(19) United States
(12) Patent Application Publication
(10) Pub. No.: US 2004/0209053 A1
(43) Pub. Date: Oct. 21, 2004

(54) Laminated safety glass pane with predetermined breaking point and impact point, method for the production and use thereof

(76) Inventors: Klaus Holtmann, Hannover (DE); Hans Weinfurtner, Wernberg-Koblitz (DE); Mario Tassarek-Metz, Isernhagen (DE); Michael Schwamb, Frankfurt (DE)

Correspondence Address: FULBRIGHT & JAWORSKI, LLP, 666 FIFTH AVE, NEW YORK, NY, 10103-3198, US

(21) Appl. No.: 10/487,397

(22) PCT Filed: Aug. 6, 2002
(86) PCT No.: PCT/DE02/02888

(30) Foreign Application Priority Data
Aug. 21, 2001 (DE) 101 39 959.6

(51) Int. Cl. B32B 3/00

(52) U.S. Cl. 428/204

(57) ABSTRACT

A laminated safety glass pane having a predetermined breaking location and an impact point is described which contains at least two toughened glass panes and an intermediate layer, wherein predetermined breaking lines (=the predetermined breaking location), which are formed by discontinuities in the intermediate layer, are present in order to create an emergency exit and the intermediate layer is embodied in one location (for example on one side) of the laminated safety glass such as to be flexible and not able to be broken through, such that when the predetermined breaking lines are broken through, an emergency exit flap is formed which is connected to the remainder of the pane in tear-resistant manner and in a manner pivotable therewith by means of a hinged joint, and wherein the laminated glass pane contains, in at least one location (at the impact point) in the intermediate layer, one or more bodies made of a material whereof the hardness is greater than that of the glass used.

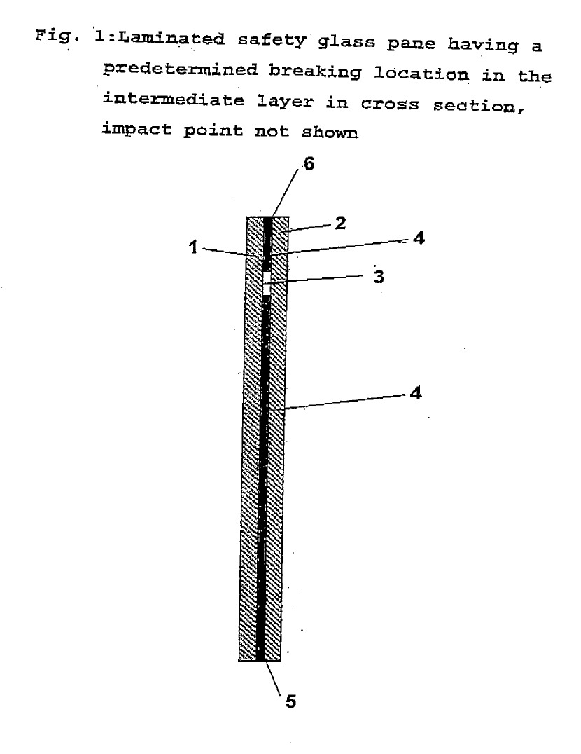

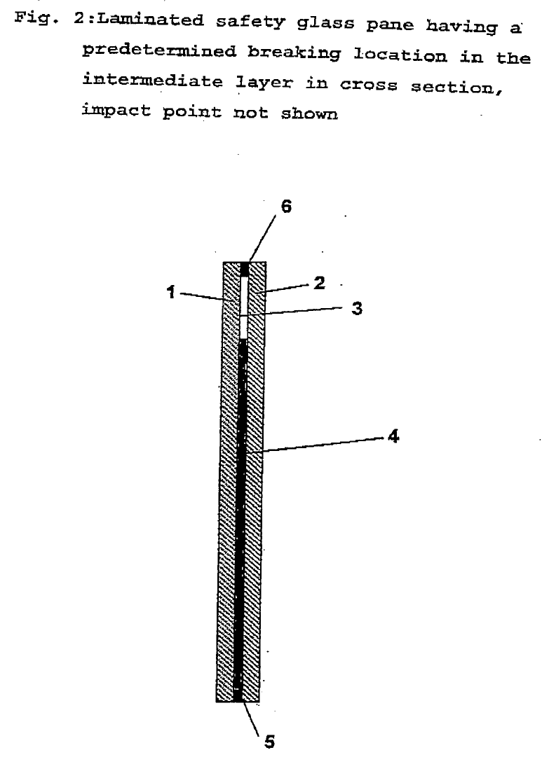

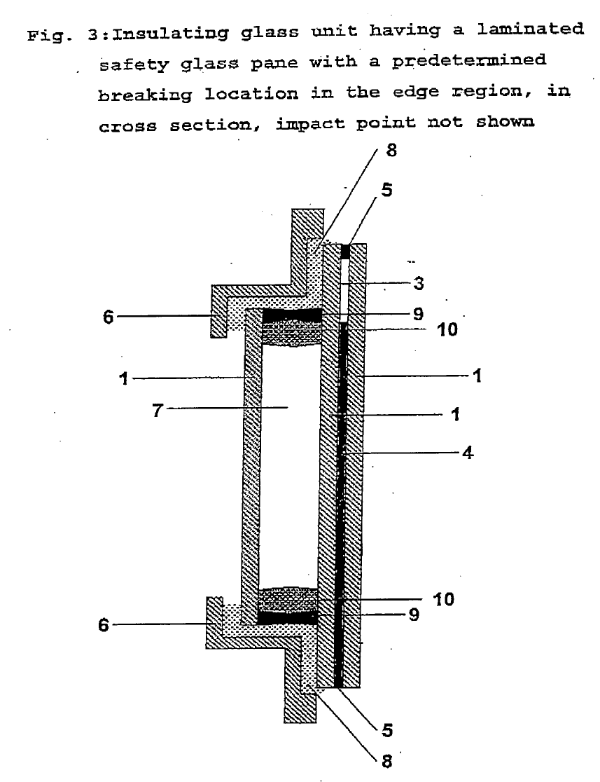

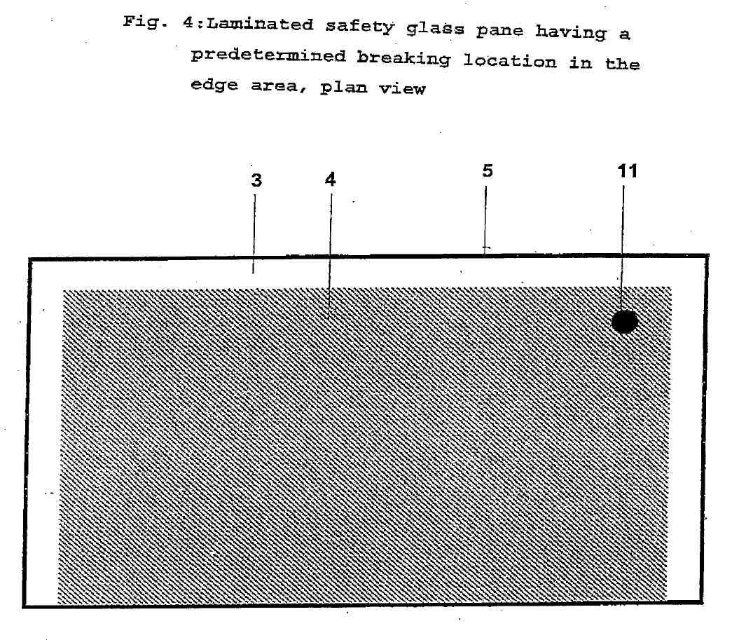

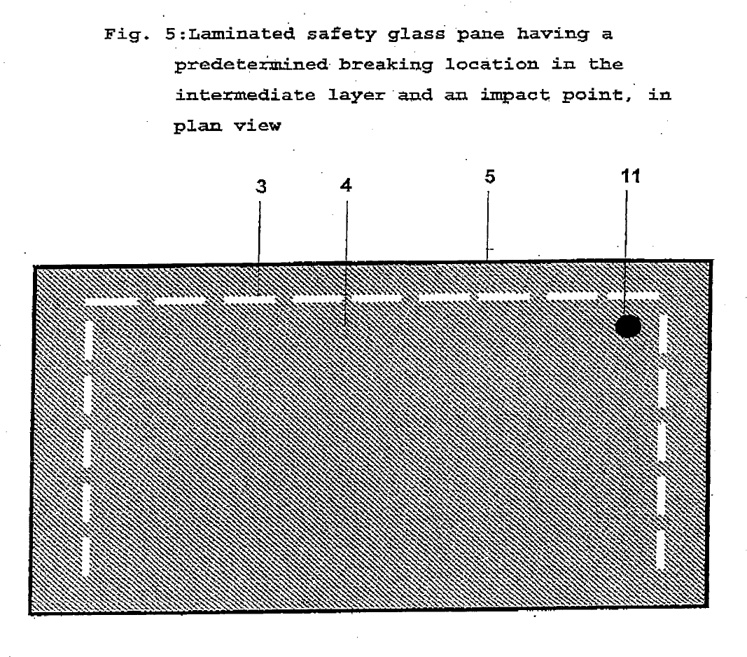

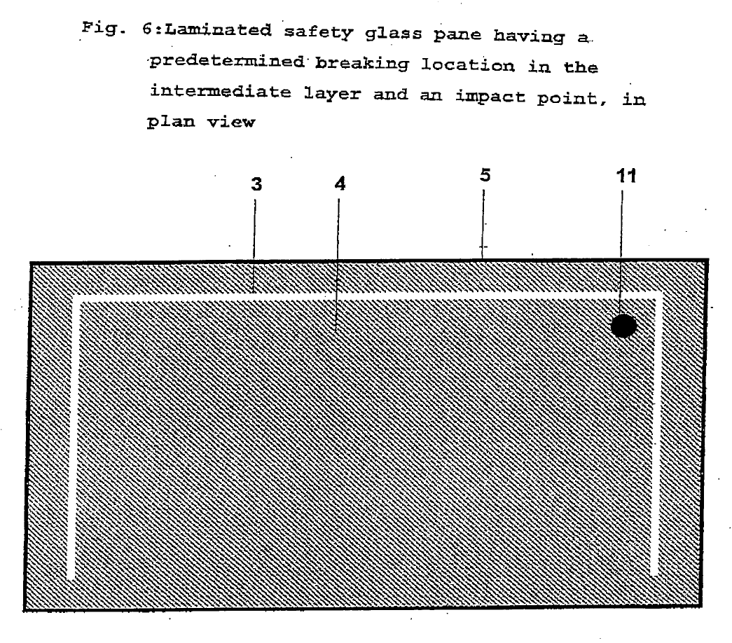

The invention relates to a laminated safety glass pane having a predetermined breaking location and an impact point, which may be used, for example, for an emergency exit system or emergency entry system, as well as a process for the production of a laminated safety glass pane having a predetermined breaking location, and the use of the laminated safety glass pane having a predetermined breaking location.

Laminated safety glass panes (LSG panes) having an emergency exit system are known from DE 4428690 and U.S. Pat. No. 5,350,613. Such laminated safety glass panes consist of at least two panes having a polymeric intermediate layer, with a predetermined breaking location being contained in the intermediate layer.

The predetermined breaking location described in DE 4428690 is represented by a local weakening of the interlying polymeric layer. This is achieved by decreasing the adhesion of the layer to the glass or alternatively, decreasing the adhesion between different plies of the layer itself. This solution has the following disadvantages:

If the adhesion of the layer to the two glass panes is reduced, then, if the two panes are shattered a gap results in which the space is nevertheless still closed off by the intermediate layer despite the glass falling away from the latter. Admittedly, this layer can be stretched and, if sufficiently highly loaded, also tears. However, this results in an insufficiently large opening in the pane and the function of an emergency exit is not ensured. Further random tearing-open of the layer is possible only when the tensile strength of the polymeric intermediate layer is relatively low, and this has a disadvantageous effect on the function as a laminated safety glass. If a polymeric intermediate layer having a higher tear strength is used, this must, under some circumstances, be cut open with an additional tool (column 3, paragraph 1). One should, however, be aware that in an emergency this may not be known to a passenger, who may panic. The random tearing-open of the polymeric intermediate layer furthermore gives rise to a very small exit opening bordered by irregular edges of cracks. There is therefore a likelihood of severe lacerations resulting from making an exit through the opening in the glass.

If adhesion between different regions of the polymeric intermediate layer is reduced further, the effort required to create an open port in the glass pane is admittedly reduced. However, such a port is still inadequate for the rapid forming of an emergency exit opening. The problem of non-oriented tear propagation in the polymeric intermediate layer still remains, as does the limited resistance to tearing of the intermediate layer.

Smashing both panes of the laminated safety glass device requires a pointed hammer, which is provided for this purpose. If the striking tool is blunt, the intermediate layer acts as a shock absorber and it is not possible to break through the polymeric intermediate layer to the surface of the second pane. For this reason, when using a tool other than a pointed hammer (toughened safety glass hammer) shattering of the second glass pane ranges from very difficult to impossible.

The utilisation of float glass in the described laminated glass pane having an emergency exit system is not to be recommended because dagger-like sharp-edged fragments form when float glass is smashed (added risk of injury) and these dagger-like fragments bridge the predetermined breaking location, thus limiting its function.

A further disadvantage resides in the resistance to tearing of the intermediate layer, which is only low. After one part of a pane has become loose, the part of the pane which still remains in the frame may break away under its own weight, possibly leading to injury

The laminated glass pane having a predetermined breaking location, which is described in U.S. Pat. No. 5,350,613, has the following disadvantages. The piercing of both panes at the “impact point” with a single blow is possible only with a toughened safety glass hammer having a correspondingly long spike. However, such a hammer can be used as a weapon and is therefore classed as a security risk.

The predetermined breaking location is produced having an adhesive band of double-sided adhesive foam material. The marked extensibility and compressibility of the foam material can lead to difficulties when producing the panes, because during charging with casting resin, the hydrostatic pressure in the region of the predetermined breaking location brings about a change in the layer strength.

A ruptured pane is held together only by bridges of cured, tear-resistant casting resin which are present between the foam material pieces. The residual load-carrying capacity of such a ruptured pane may be inadequate if an insufficiently tear-resistant intermediate layer is used, and this may, for example, cause the broken glass layer, which has come loose, to break away and fall onto people. If, on the other hand, a highly tear-resistant intermediate layer is used, as would be necessary in order to achieve a high residual load-carrying capacity, there is a risk of the casting resin bridges failing to tear when under load, limiting the function of the emergency exit.

EP 1002641 A1 describes a vehicle window of laminated safety glass having two toughened safety glasses bonded by an intermediate layer, with the intermediate layer containing predetermined breaking lines (=the predetermined breaking location) constituted by discontinuities in the intermediate layer, and the intermediate layer in a marginal region of the laminated safety glass being produced such as to be flexible and not able to be broken through, such that when the predetermined breaking lines are broken through, an emergency exit flap is formed which is connected to the vehicle in tear-resistant manner and in a manner pivotable therewith. In EP 1002641 A1 a pointed hammer is mounted inside the vehicle in the vicinity of the window in case of the need for smashing the laminated safety glass with a suitable tool. A disadvantage of this arrangement likewise is the fact that it is possible to penetrate both panes at the “impact point” with a single blow only with a toughened safety glass hammer having a correspondingly long spike. However, such a hammer can be used as a weapon and is therefore classed as a security risk.

The object of the present invention is to avoid the described disadvantages of the prior art and in particular to create a laminated safety glass pane (LSG pane) in which, without a special tool, an emergency exit opening can be produced in the pane in order, in an emergency, to afford to people inside a vehicle or building the opportunity of leaving it through this opening or in order to afford to rescue personnel the opportunity of gaining access to the inside of a vehicle or a building without a special tool.

The object is achieved by means of a laminated safety glass pane having a predetermined breaking location and an impact point, which contains at least two toughened glass panes and an intermediate layer, wherein predetermined breaking lines (=the predetermined breaking location) which are formed by discontinuities are present in the intermediate layer in order to create an emergency exit and the intermediate layer is formed in one location (for example on one side) of the laminated safety glass such as to be flexible and not able to be broken through, such that when the predetermined breaking lines are broken through, an emergency exit flap is formed which is connected to the remainder of the pane in tear-resistant manner and in a manner pivotable therewith in the manner of a hinged joint, and wherein the laminated glass pane contains in at least one location (at the impact point) in the intermediate layer, one or more bodies made of a material the hardness of which is greater than that of the glass used. The intermediate layer preferably contains at the impact point a recess, for example of circular geometry, it which the hard bodies are arranged. These are preferably embedded in a soft and plastic synthetic material. This “embedding synthetic plastics material” may be a cured casting resin having corresponding properties and/or a polymeric film, for example of polyisobutylene.

Flat glasses from the alkali-lime glass group, such as soda-lime glass (for example in accordance with DIN EN 572, 1-7), or borosilicate glasses may be utilised as the glass panes. The glass panes are toughened or heat-strengthened.

The heat-strengthening or toughening may be effected by thermal means (in accordance with DIN EN 12150, 96/2 and/or DIN EN 1863/1 2000/3 and/or DIN EN 13024/1 98/1) or by chemical means. The thickness of the glass panes is preferably from 0.1 to 12 mm, and particularly preferably from 0.5 to 6 mm. A thickness of from 1 to 4 mm is optimal.

In the present context a discontinuity in the intermediate layer is understood to mean a discontinuity in the bond between the two glass plates which provides the intermediate layer. Because of the incompleteness of the bond a discontinuity constitutes a weakening line or predetermined breaking line (=the predetermined breaking location). Discontinuities may be embodied in the form of cohesive lines, strips or elongate surface regions in the intermediate layer.

In an emergency both glass panes can be shattered by a single blow to the impact point from a blunt body, for example a rubber hammer. This is achieved by the body or bodies which is/are located at the impact point in the intermediate space of the LSG pane being made of a material whose hardness exceeds that of the glass. The bodies preferably have a Mohs' hardness of >6, particularly preferably of >7. The hard bodies preferably consist of grains or spheres. In particular, grains which are sharp-edged are ideally preferred. Bodies made of silicon carbide or corundum, for example, is may be utilised, Here, the hard bodies may here be firmly inserted into the space provided for them between the two outer glass panes by means of a soft and synthetic plastics material (such as, for example, polyisobutylene, also known as butyl). It is preferable to select the body size such that this is from 0.1 to 0.3 mm, particularly preferably 0.1 mm, smaller than the thickness of the intermediate layer.

If now a high pressure is built up in pulsed manner in the region of the impact point, for example as a result of a blow from a blunt body, then the hard bodies are pressed against both pane surfaces at a sufficiently high pressure by the local deflection of the pane in the region of the hammer blow. Under the penetrating body or bodies, a crack, which is perpendicular to the surface of the glass, hereby forms in the glass. If the crack opening finds the tensile stress zone of the toughened glass, the entire pane breaks in known manner. Opening of the emergency exit is then possible at the predetermined breaking location. Application of a force in the vicinity of the predetermined breaking location (for example by simple manual pressure) enables the emergency exit to be opened

By way of example, the following values may be indicated for the mechanical fracturing properties and the hardness of the intermediate layer:

| | | |
|---|---|---|
| Tear strength | at least 4 | preferably at least |
| | MPa, | 10 MPa; |
| Elongation at break | at least | preferably at least |
| | 200%, | 300%; |
| Tear propagation | at least 6 | preferably at least |
| resistance | N/mm, | 15 N/mm; |
| Shore A hardness | 30 to 70, | preferably 40 to 60. |

The intermediate layer may be produced from a synthetic-plastics material This plastics material may contain or consist of a thermoplastic adhesive film. The constituents of the adhesive film may be selected from the group of polyvinyl acetals or polyurethanes.

A process for the production of a laminated safety glass pane having a predetermined breaking location according to the invention may be indicated as follows:

Predetermined breaking lines and at least one region which subsequently contains the hard bodies (impact point) are cut or punched out from a polymeric film. The predetermined breaking location preferably takes the form of three sides of a rectangle located within the surface area of the glass plate. A thermally toughened glass plate is provided with an edge seal, and the prepared film is laid as the intermediate layer onto the glass plate. One or more hard bodies which have a hardness greater than that of the glass are positioned at the impact point. This preferably takes place during an embedding of the hard bodies in polyisobutylene, a description of effecting the embedding being provided further below, A second thermally toughened glass plate is laid down in congruent manner onto this arrangement. The laminate thus produced is moved in known manner between pairs of rolls through a heated zone. Air still contained within the laminate is then removed by treating the laminate in an autoclave.

The LSG pane obtained having an emergency exit system may be processed as a single LSG pane. The LSG pane having a predetermined breaking location may also be processed in ordinary multi-pane insulating glass, wherein one or more panes of the multi-pane insulating glass may consist of the LSG pane having a predetermined breaking location according to the invention.

The LSG pane according to the invention may be used in buildings, as well as in rail, road and water vehicles.

The embedding of the hard bodies in polyisobutylene (for use as an impact point) may be effected in the following manner:

A thin film is made from a butyl sealant (sealant containing a homopolymer, copolymer or terpolymer of isobutylene or mixtures thereof, or a copolymer of acrylates or methacrylates or mixtures thereof, optionally together with other conventional additives; for example Naftotherm TPS from Chemetall GmbH). This may take place in a platen press by pressing an approximately 10 mm cube of the sealant to a thickness of 0.8 mm. This preferably takes place by means of two metal press platens and a 0.8 mm thick metal spacer. Round components of film, so-called pads, (approximately 30 mm in diameter) are punched out from the film thus produced. One or more hard bodies, for example SiC grains, is/are then placed onto the centre of a horizontally lying pad. Tests have shown a count of from 10 to 30 SiC grains to be very effective. For example, SiC grains from ESK-SIC GmbH, grade P14 (1.70 mm 20%, 1.40 mm 45%, 1.18 mm 70%) or grade F16 (1.40 mm 20%, 1.18 mm 45%, 1.00 mm 70 mm) may be utilised as the SiC grains. Screening of the grains in order to exclude grain sizes exceeding the maximum grain size (as dictated by the distance between the two glass plates) is recommended. A second pad is then laid down in a congruent manner onto the first over the hard bodies.

This structure is pressed to a thickness of approximately 1.6 mm between two metal plates. The embedding of bodies in polyisobutylene, which is utilisable as an impact point, is punched but from this pressed moulding, to a diameter of approximately 30 mm. The inherent tack of the butyl sealant makes handling with the aid of silicone paper preferable.

The laminated safety glass pane having a predetermined breaking location preferably has an edge seal made of a thermoplastic material which remains permanently plastic at room temperature. This material may be formed from a polymer which may have either partial cross-linking or no cross-linking. The polymer may be based on, for example, homopolymers, copolymers or terpolymers of isobutylene or mixtures thereof, as well as on copolymers of acrylates or methacrylates or mixtures thereof (base polymer).

Further constituents of the thermoplastic materials may be thermoplastic polymers, natural and synthetic rubbers, tackifying additives, plasticisers, coupling agents, reinforcing and non-reinforcing tillers, stabilisers, drying agents and other additives.

Homopolymers of isobutylene are polyisobutylenes which are commercially obtainable in various molecular weight ranges. Examples of polyisobutylene trade names are Oppanol (BASF AG), Vistanex (Exxon) and Efrolen (Efremov). The polyisobutylenes range from the liquid state, through a soft resin-like state to rubber-like. The molecular weight ranges may be indicated as follows: the number average molecular weight is from 2,000 to 1,000,000 g/mol, preferably 24,000 to 600,000 g/mol, and the viscosity average molecular weight is from 5,000 to 6,000,000 g/mol, preferably 40,000 to 4,000,000 g/mol.

Copolymers and terpolymers of isobutylene contain as comonomers and termonomers 1,3-dienes such as isoprene, butadiene, chloroprene or β-pinene, functional vinyl compounds such as styrene, α-methylstyrene, p-methylstyrene or divinylbenzene, or further monomers. An example of a copolymer of isobutylene and isoprene is butyl rubber having a low isoprene content; various butyl products from the companies Bayer AG, Exxon Chemical and Kautschuk-Gesellschaft, for example, are commercially obtainable. Terpolymers of isobutylene with the monomers isoprene and divinylbenzene yield partially cross-linked butyl rubber products which are also obtainable by subsequent cross-linking of butyl rubber; LC Butyl from Exxon Chemical, Kalar from Hardman and Polysar Butyl XL from Bayer AG, for example, are commercially obtainable. The homopolymers, copolymers and terpolymers of isobutylene may also undergo a subsequent chemical modification; the reaction of butyl rubber with halogens (chlorine, bromine), leading to chlorinated or brominated butyl rubber, is known. A copolymer of isobutylene and p-methylstyrene is similarly reacted with bromine to form the terpolymer of isobutylene, p-methylstyrene and p-bromomethylstyrene, which is commercially obtainable under the trade name EXXPRO from Exxon Chemical.

Homopolymers or copolymers of acrylates or methacrylates (poly(meth)acrylates) are polymers of the esters of acrylic or methacrylic acid and may, for example, include an alcohol component, an alkyl group which may be substituted with functional groups or unsubstituted, for example methyl, ethyl, propyl, isopropyl, n-butyl, isobutyl, tert.-butyl, pentyl and hexyl and isomers and higher homologues thereof, 2-ethylhexyl, phenoxyethyl, hydroxyethyl, 2-hydroxypropyl, caprolactone hydroxyethyl, dimethylaminoethyl. Polymers of acrylic acid, methacrylic acid, of amides of the named acids and of acrylonitrile are also included. Partially cross-linked poly(meth)acrylates in which cross-linking is by way of a polyfunctional monomer having, for example, diethylene glycol or trimethylolpropane as the alcohol component, and mixtures of polyacrylates and polymethacrylates, may also be used.

Examples of thermoplastic polymers are polyolefins as homopolymers and copolymers, constructed from the monomers ethylene, propylene, n-butene and higher homologues and isomers thereof and from functional vinyl compounds such as vinyl acetate, vinyl chloride, styrene and α-methylstyrene. Further examples are polyamides, polyimides, polyacetals, polycarbonates, polyesters and polyurethanes and mixtures of the polymers mentioned

Natural and synthetic rubbers may be selected from the group of homopolymers of dienes, the group of copolymers and terpolymers of dienes with olefins and the group of copolymers of olefins. Examples are polybutadiene, polyisoprene, polychloroprene, styrene-butadiene rubber, block copolymers having blocks of styrene and butadiene or isoprene, ethylene-vinyl acetate rubber, ethylene-propylene rubber and ethylene-propylene-diene rubber, for example, having as the diene component, dicyclopentadiene or ethylidene norbornene. The rubbers may also be utilised in hydrogenated form and also in mixtures.

Tackifying additives may be selected from the group of natural and synthetic resins, including those which are subsequently modified, including, inter alia, hydrocarbon resins, colophony and derivatives thereof, polyterpenes and derivatives thereof, cumarone-indene resins and phenolic resins, and from the group comprising polybutenes, polyisobutenes and degraded liquid rubbers (for example butyl rubber or EPDM), which may also be hydrogenated. Mixtures of the tackifying additives listed may also be utilised.

Examples of plasticisers are esters of phthalic acid (for example di-2-ethylhexyl phthalate, diisodecyl phthalate, diisobutyl phthalate and dicyclohexyl phthalate), esters of phosphoric acid (for example 2-ethylhexyldiphenyl phosphate, tri(2-ethylhexyl) phosphate and tricresyl phosphate), esters of trimellitic acid (for example tri(2-ethylhexyl) trimellitate and triisononyl trimellitate), esters of citric acid (for example acetyl tributyl citrate and esters acetyl triethyl citrate) and of dicarboxylic acids (for example di-2-ethylhexyl adipate and dibutyl sebacate). Mixtures of the plasticisers may also be utilised.

Coupling agents may be selected from the group of silanes, which may include, for example, 3-glycidyloxypropyl trialkoxysilane, 3-aminopropyl trialkoxysilane, N-aminoethyl-3-aminopropyl trialkoxysilane, 3-methacryloxypropyl trialkoxysilane, vinyl trialkoxysilane, isobutyl trialkoxysilane, 3-mercaptopropyl trialkoxysilane, from the group of silicic acid esters, for example tetraalkyl orthosilicates, and from the group of metallates, for example tetraalkyl titanates or tetraalkyl zirconates, as well as mixtures of the coupling agents listed.

Stabilisers may be antioxidants of the sterically hindered phenol type (for example tetrakis[methylene-3-(3,5-di-tert.-butyl-4-hydroxyphenyl)-propionate] methane) or of the sulfur-based antioxidant type such as mercaptans, sulfides, polysulfides, thiourea, mercaptals, thioaldehydes, thioketones, etc. or UV stabilisers of the benzotriazole, benzophenone or HALS (hindered amine light stabiliser) type or anti-ozonants. These may be utilised either alone or in mixtures.

Examples of reinforcing and non-reinforcing fillers are pyrogenic and precipitated silica, silica gel, precipitated or ground chalk (including surface-treated), clay, kaolin, talc, quartz, zeolites, titanium dioxide, glass fibres and powdered aluminium and powdered zinc and mixtures thereof. If a dark coloured plastics material which forms the predetermined breaking location is not considered problematic, carbon black, carbon fibres or graphite may also be utilised.

Fillers which bind water, such as, for example, calcium oxide or zeolites may be utilised as drying agents. Zeolites which bind water very effectively but are not suitable for absorbing gases such as nitrogen, oxygen or argon are preferred. The pore diameter of such zeolites is, for example, 3 Å. Mixtures of the drying agents may also be utilised.

An embodiment of the thermoplastic material which is preferably used has the following constituents (indicated as percentages by weight)

| | |
|---|---|
| a) base polymer | 30-100 |
| b) thermoplastic polymers | 0-50 |
| c) natural and synthetic rubbers | 0-50 |
| d) tackifying additives | 0-30 |
| e) plasticisers | 0-50 |
| f) coupling agents | 0-5 |
| g) stabilisers | 0-5 |
| h) reinforcing and non-reinforcing | 0-70 |
| fillers. | |
| i) drying agents | 0-40 |

The material which is used particularly preferably contains the following constituents:

| | |
|---|---|
| a) base polymer | 40-100 |
| b) thermoplastic polymers | 0-30 |
| c) natural and synthetic rubbers | 0-30 |
| d) tackifying additives | 0-25 |
| a) plasticisers | 0-30 |
| f) coupling agents | 0-3 |
| g) stabilisers | 0-3 |
| h) reinforcing and non-reinforcing | 0-60 |
| fillers | |
| i) drying agents | 0-20 |

It is advantageous to the edge seal in the described laminated safety glass pane having a predetermined breaking location that the edge seal forms a moisture penetration barrier for the voids (discontinuities) and that, if it contains a drying agent, it dries the gas, generally air, which is present in the voids. It also protects the intermediate layer from moisture, which finally avoids fogging of the intermediate layer. The edge seal furthermore prevents diffusion of plasticisers (for example from the mountings which surround the laminated safety glass pane) into the intermediate layer and the voids of the intermediate layer, and this likewise avoids fogging of the intermediate layer.

1. A laminated safety glass pane having a predetermined breaking location and an impact comprising at least two toughened glass panes and an intermediate layer, wherein predetermined breaking lines which are formed by discontinuities in the intermediate layer, are present in order to create an emergency exit, and, the intermediate layer is embodied in one location of the laminated safety glass such as to be flexible and not able to be broken through, such that when the predetermined breaking lines are broken through, an emergency exit flap is formed which is connected to the remainder of the pane in a tear-resistant manner and in a manner pivotable therewith by means of a hinged joint, characterised in that the laminated glass pane contains, in at least one location at the impact point in the intermediate layer, one or more bodies made of a material whereof the hardness is greater than that of the glass used.

2. The laminated safety glass pane having a predetermined breaking location according to claim 1, wherein as the glass panes, flat glasses are selected from the group of alkali-lime glasses, such as soda-lime glass, or borosilicate glasses.

3. The laminated safety glass pane having a predetermined breaking location according to claim 1, wherein the Mohs' hardness of the hard body or hard bodies at the impact point is >6.

4. The laminated safety glass pane having a predetermined breaking location according to claim 3, wherein the Mohs' hardness of the hard body or bodies at the impact point is >7.

5. The laminated safety glass pane having a predetermined breaking location according to claim 1, wherein the hard bodies consist of grains or spheres.

6. The laminated safety glass pane having a predetermined breaking location according to claim 1, wherein the hard body or bodies at the impact point consists/consist of silicon carbide and/or corundum.

7. The laminated safety glass pane having a predetermined breaking location according to claim 1, wherein the size of the hard bodies is from 0.1 to 0.3 mm smaller than the thickness of the intermediate layer.

8. The laminated safety glass pane having a predetermined breaking location according to claim 1, wherein the hard bodies are embedded in polyisobutylene.

9. The laminated safety glass pane having a predetermined breaking location according to claim 1, wherein the intermediate layer is formed from a plastics material having the following mechanical fracturing properties; tear resistance at least 4 MPa, elongation at break of at least 200%, tear propagation resistance of at least 6 N/mm, Shore A hardness (in accordance with DIN 53505, determined at 23° C. on 6 mm-thick test specimens), of from 30 to 70.

10. The laminated safety glass pane having a predetermined breaking location according to claim 1, wherein the intermediate layer contains a casting resin and/or a polymeric film.

11. The laminated safety glass pane having a predetermined breaking location according to claim 10, wherein the casting resin for the production of the intermediate layer is based on polyacrylate.

12. The laminated safety glass pane having a predetermined breaking location according to claim 1, wherein the laminated safety glass pane contains an edge seal made of a thermoplastic material which is permanently plastic at room temperature.

13. A process for the production of a laminated safety glass pane having a predetermined breaking location, characterised in that
a) predetermined breaking lines and at least one region which subsequently contains the hard bodies (the impact point) are cut or punched out from a polymeric film,
b) a thermally toughened glass plate is provided with an edge seal,
c) the film prepared under a) is laid as an intermediate layer onto the glass plate,
d) one or more hard bodies having a hardness greater than that of the glass is/are applied to the glass plate at the impact point,
e) a second thermally toughened glass plate is laid down onto this arrangement, and
f) the resulting glass plate laminate is pressed.

14. (canceled)

15. A building comprising the laminated safety glass pane of claim 1.

16. A vehicle comprising the laminated safety glass pane of claim 1.
